(19) United States
(12) Patent Application Publication
(10) Pub. No.: US 2007/0078051 A1
(43) Pub. Date: Apr. 5, 2007

(54) Method for manufacturing electrode layer for fuel cell

(75) Inventors: Tomoko Tamai, Haga-gun (JP); Tomohide Shibutani, Haga-gun (JP); Youhei Kobayashi, Haga-gun (JP)

Correspondence Address: ARENT FOX PLLC, 1050 CONNECTICUT AVENUE, N.W., SUITE 400, WASHINGTON, DC, 20036, US

(73) Assignee: HONDA MOTOR CO., LTD.

(21) Appl. No.: 11/523,665

(22) Filed: Sep. 20, 2006

(30) Foreign Application Priority Data
Sep. 30, 2005 (JP) 2005-288603

(51) Int. Cl. H01M 4/88

(52) U.S. Cl. 502/101

(57) ABSTRACT

A method for manufacturing an electrode layer for a fuel cell includes applying a paste-form electrode material, having a solvent that includes an ion-exchange resin, to a sheet-form base, and evaporating the solvent on a front surface of a layer of the electrode material so that the concentration of the ion-exchange resin in the electrode material layer formed on the base increases from a front surface toward a reverse surface, opposed to the base, of the electrode material layer.

### FIELD OF THE INVENTION

The present invention relates to a method for manufacturing an electrode layer for a fuel cell, wherein a paste-form electrode material is applied to a sheet-shaped base material, and the coated electrode material is solidified to form an electrode layer.

### BACKGROUND OF THE INVENTION

A common fuel cell is configured in the manner shown in FIG. 12 hereof showing a main part of a common fuel cell.

A common fuel cell 100 comprises an ion-exchange membrane 101, a cathode 102 laminated to one surface of the ion-exchange membrane 101, an anode 103 laminated to the other side of the ion-exchange membrane 101, a cathode diffusion layer 104 laminated to the cathode 102, and an anode diffusion layer 105 laminated to the anode 103. The cathode diffusion layer 104 has an external oxygen gas channel (not shown). The anode diffusion layer 105 has an external hydrogen gas channel (not shown).

Oxygen gas fed from the oxygen gas channel flows into the cathode 102. As a result, oxygen molecules (O₂) come into contact with a catalyst inside the cathode 102. Hydrogen gas fed from the hydrogen gas channel flows into the anode 103. As a result, hydrogen molecules (H₂) come into contact with a catalyst inside the anode 103. For this reason, a reaction is induced within the cathode 102 and the anode 103.

As a result of the reaction, the hydrogen molecules (H₂) are separated into electrons and hydrogen ions (H⁺) in the anode 103. The generated hydrogen ions pass through the ion-exchange membrane 101 and flow to the cathode 102. The electrons travel through an external circuit and migrate to the cathode 102. Water (H₂O) is produced by the reaction of the oxygen molecules, hydrogen ions, and electrons in the cathode 102. At this point, electric current flows from the cathode 102 to the anode 103.

The reaction of oxygen molecules, hydrogen ions, and electrons is particularly accelerated in an area 102a (layer 102a indicated by the broken-line hatching) of the cathode 102 in the vicinity of the boundary 106 with the ion-exchange membrane 101.

A cathode for a fuel cell and a manufacturing method of the same is disclosed in Japanese Patent Laid-Open Publication No. 2004-47455 (JP-A-2004-47455). In this cathode, the content of ion-exchange resin in the area 102a is increased so as to particularly promote the reaction of oxygen molecules and hydrogen ions.

The cathode disclosed in JP-A-2004-47455 comprises two layers, i.e., an upper first electrode layer and a lower second electrode layer. The second electrode layer is disposed on a surface in contact with an ion-exchange membrane. The first electrode layer is disposed on a surface separated from the ion-exchange membrane. The content of ion-exchange resin in the second electrode layer is greater than the content of ion-exchange resin in the first electrode layer. The adhesion between the cathode and the ion-exchange membrane increases by increasing the content of ion-exchange resin in the second electrode layer. Also, the reaction between the oxygen molecules and the hydrogen ions proceeds with good efficiency in the area of the cathode adjacent to the boundary with the ion-exchange membrane.

Following is description of the method for manufacturing a cathode disclosed in JP-A-2004-47455. A first electrode layer is formed by spraying a paste-form electrode material over a sheet-form cathode diffusion layer at a low spray pressure. Next, a paste-form electrode material is sprayed at a high spray pressure to form a second electrode layer on the first electrode layer. An ion-exchange membrane solution is then applied to the second electrode layer to form an ion-exchange membrane.

In this manner, when a paste-form electrode material is applied, the content of ion-exchange resin in the first and second electrode layers is varied by varying the pressure of the spray. As a result, the content of ion-exchange resin in the second electrode layer is increased.

However, in the method for manufacturing a cathode disclosed in JP-A-2004-47455, it is necessary to separately carry out the step for applying a first electrode layer and the step for applying the second electrode layer. For this reason, time is required to apply a cathode (electrode layer for a fuel cell). This fact is an obstruction to increasing the production rate of fuel cells.

In view of the above, a manufacturing method is needed that can increase the production rate of fuel cells.

### SUMMARY OF THE INVENTION

According to the present invention, there is provided a method for manufacturing an electrode layer for a fuel cell, comprising the steps of: providing a paste-form electrode material having a solvent that includes an ion-exchange resin; applying the electrode material to a sheet-form base; evaporating the solvent on a front surface of a layer of the electrode material so that a concentration of the ion-exchange resin contained in the electrode material layer applied to the base increases from the front surface toward a reverse surface, opposed to the base, of the electrode material layer; and solidifying the electrode material layer by drying.

When solvent on the front surface of the electrode material layer is thus evaporated and removed, the concentration of the ion-exchange resin contained in the solvent on the front surface increases. A difference can be created in the concentration of the ion-exchange resin contained in the solvent on the front and reverse surfaces of the electrode material layer. The ion-exchange resin tends to form a uniform concentration and spreads (moves) from the high concentration side to the low concentration side. The ion-exchange resin on the front surface spreads to the reverse surface, causing the content of ion-exchange resin in the front surface to be reduced, and the content of ion-exchange resin in the reverse surface to be increased. As a result, the concentration of the ion-exchange resin in the electrode material layer gradually increases from the front surface toward the reverse surface of the electrode material layer. In other words, a concentration gradient can be formed so that the concentration of ion-exchange resin increases from the front surface to the reverse surface of the electrode material layer. In this state, the electrode material layer is solidified by drying and the electrode layer is completed. As a result, the concentration gradient of the ion-exchange resin is stabilized.

In this fashion, an electrode layer having a concentration gradient in the ion-exchange resin can easily be manufactured by using a simple manufacturing method in which the solvent on the front surface of the electrode material layer is evaporated before the electrode material layer is dried. The production rate of fuel cells can therefore be increased.

In a preferred form, the step for evaporating the solvent on the front surface comprises blowing air onto the front surface to facilitate evaporation of the solvent from the front surface.

Desirably, the step for evaporating the solvent on the front surface comprises setting an evaporation rate of the solvent contained in the electrode material layer to fall in a range of 23 to 66 wt %.

Preferably, the step for evaporating the solvent on the front surface comprises heating the electrode material layer to a temperature that allows the solvent contained in the electrode material layer to evaporate from the front surface and that prevents occurrence of convection of the solvent within the electrode material layer.

### BRIEF DESCRIPTION OF THE DRAWINGS

Certain preferred embodiments of the present invention will be described in detail below, by way of example only, with reference to the accompanying drawings, in which:

FIG. 1 is a schematic view of a fuel cell provided with the electrode layer for a fuel cell of the present invention;

FIG. 2 is a cross-sectional view showing a main part of the cell shown in FIG. 1;

FIG. 3 is a schematic view of a manufacturing device for manufacturing the electrode layer for a fuel cell shown in FIG. 2;

FIG. 4 is a schematic view of the concentration gradient chamber shown in FIG. 3;

FIG. 5 is a schematic view of a main part of the electrode layer for a fuel cell and the concentration gradient chamber;

FIGS. 6A to 6C are an explanatory views of the method for manufacturing an electrode layer for a fuel cell;

FIGS. 7A and 7B are explanatory views of the method of measuring the carbon and the ion-exchange resin contained in the electrode layer for a fuel cell and the ratio of carbon and ion-exchange resin;

FIG. 8 is a view showing the relationship between the second ion-exchange resin/carbon ratio of the electrode layer for a fuel cell and the evaporation time of the solvent in experiment 1;

FIG. 9 is a view showing the relationship between the second ion-exchange resin/carbon ratio of the electrode layer for a fuel cell and the evaporation temperature of the solvent in experiment 2;

FIG. 10 is a view showing the relationship between the second ion-exchange resin/carbon ratio of the electrode layer for a fuel cell and the air blow velocity in experiment 3;

FIG. 11 is a view showing the relationship between the evaporation rate of the solvent and the evaporation time of the solvent in experiment 4; and

FIG. 12 is a schematic view of a conventional fuel cell.

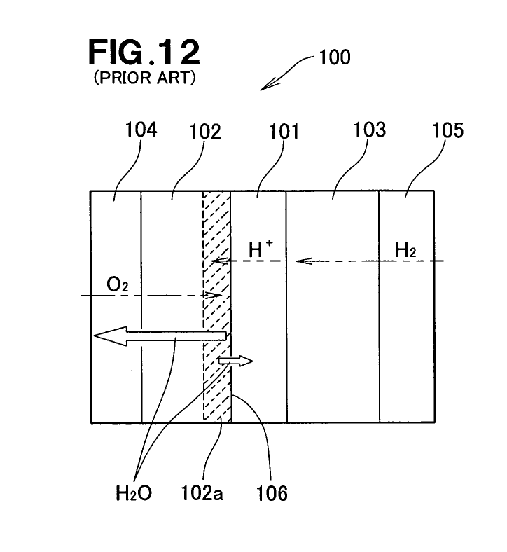

### DESCRIPTION OF THE PREFERRED EMBODIMENTS

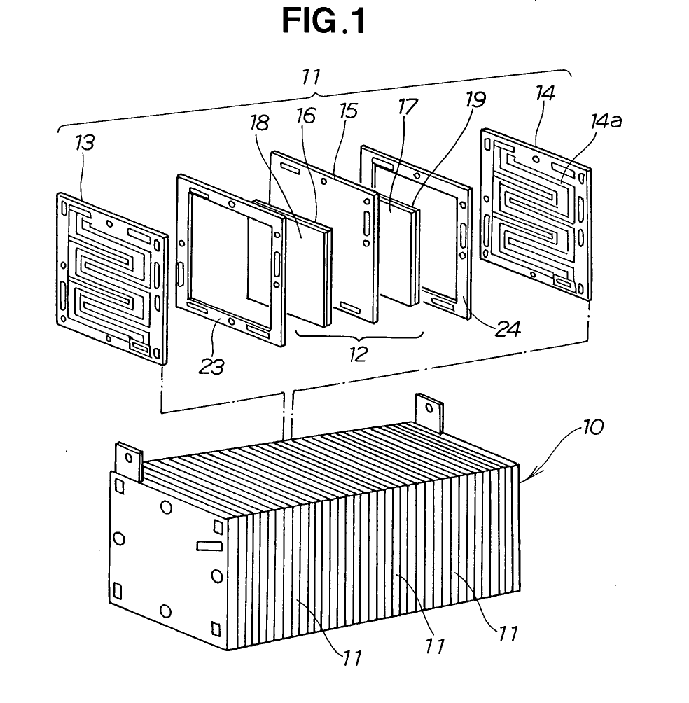

A fuel cell 10 comprises a plurality of stacked cells 11, as shown in FIG. 1. A cell 11 has a membrane electrode assembly 12, a first separator 13 laminated on one surface of the membrane electrode assembly 12, and a second separator 14 laminated on the other surface of the membrane electrode assembly 12.

The membrane electrode assembly 12 has an ion-exchange membrane 15, a cathode 16 laminated on one surface of the ion-exchange membrane 15, an anode 17 laminated on the other surface of the ion-exchange membrane 15, a cathode diffusion layer 18 laminated on the cathode 16, and an anode diffusion layer 19 laminated on the anode 17.

The cathode 16 (oxygen pole) and anode 17 (fuel pole) are the electrode layers of the fuel cell 10.

The first separator 13 is laminated on the surface of the cathode diffusion layer 18 on the side opposite from the cathode 16. The second separator 14 is laminated on the surface of the anode diffusion layer 19 on the side opposite from the anode 17. The space between the edge of the first separator 13 and the edge of the ion-exchange membrane 15 is sealed by a frame-shaped seal member 23. The space between the edge of the second separator 14 and the ion-exchange membrane 15 is sealed by a frame-shaped seal member 24.

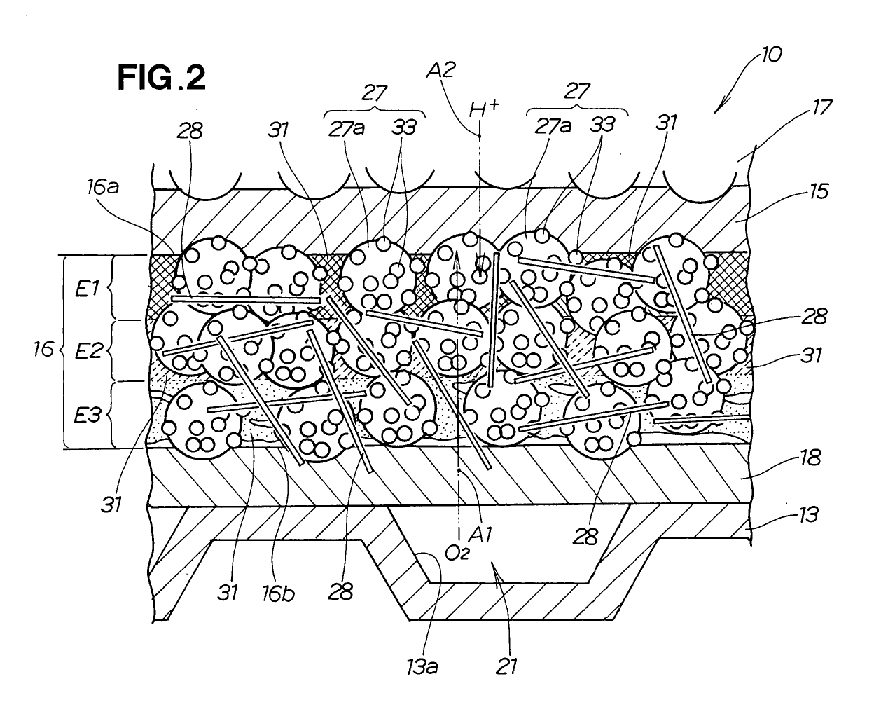

The cell 11 has an oxygen gas channel 21 (see FIG. 2) and a hydrogen gas channel (not shown). The oxygen gas channel 21 is the space between the cathode diffusion layer 18 and a groove 13a formed in the first separator 13, as shown in FIG. 2. The hydrogen gas channel is configured in the same manner as the oxygen gas channel 21. In other words, the hydrogen gas channel is the space between the anode diffusion layer 19 and a groove 14a formed in the second separator 14, as shown in FIG. 1.

The cathode 16 is described in detail next. The cathode 16 is an electrode layer composed of a material consisting of a particulate conductive material 27, a pore-forming agent 28, and an ion-exchange resin 31, as shown in FIG. 2.

The conductive material 27 is a so-called platinum-supporting carbon catalyst in which platinum 33 (noble metal catalyst 33), which has catalytic action, is supported (bonded, fixed) on the surface of particulate carbon 27a, for example.

The pore-forming agent 28 determines the void content (porosity) of the cathode 16. The void content is the ratio of the volume of the pores to the apparent volume of the material. The void content is increased by increasing the content of the pore-forming agent 28. If the void content is high, drainage increases. The pore-forming agent 28 is composed of an electroconductive acicular carbon fiber.

The ion-exchange resin 31 has an effect on adhesion with the ion-exchange membrane 15. An increase in the content of the ion-exchange resin 31 results in enhanced adhesion. The DuPont product “Nafion” (registered trademark), for example, can be used as the ion-exchange resin 31.

Here, the cathode 16 is considered as being divided into three layers, i.e., E1, E2, and E3, which are the three areas E1, E2, and E3, as shown in FIG. 2. The first area E1 is a region of the cathode 16 layer represented by crosshatching, and is the layer facing the ion-exchange membrane 15. The second area E2 is a region of the cathode 16 layer represented by broken-line hatching, and is the layer disposed between the first area E1 and third area E3. The third area E3 is a region of the cathode 16 layer represented by dots, and is the layer that faces the cathode diffusion layer 18.

The first area E1 contains a large quantity of ion-exchange resin 31. The second area E2 contains a medium quantity of ion-exchange resin 31. The third area E3 contains only a small quantity of ion-exchange resin 31. For this reason, the concentration of the ion-exchange resin 31 is lowest in third area E3 and increases in the following order: third area E3, second area E2, and first area E1. In other words, the ion-exchange resin 31 contained in the cathode 16 has a concentration gradient in which the concentration gradually increases from the cathode diffusion layer 18 toward the ion-exchange membrane 15.

In the fuel cell 10 configured in this manner, oxygen molecules (O₂) enter the cathode 16 from the oxygen gas channel 21 by way of the cathode diffusion layer 18 in the manner indicated by the arrow A1 when oxygen gas is fed to the oxygen gas channel 21. Hydrogen ions (H⁺) generated in the reaction in the anode 17 pass from the anode 17 through the ion-exchange membrane 15 to enter the cathode 16 in the manner indicated by the arrow A2. As a result, water is produced by the reaction of oxygen molecules, hydrogen ions, and electrons. The reaction of oxygen molecules, hydrogen ions, and electrons is particularly promoted in the region that is in the vicinity of the boundary 16a with the ion-exchange membrane 15 in the cathode 16, i.e., the first area E1.

The concentration of the ion-exchange resin 31 in the first area E1 is high, as described above. For this reason, the cathode 16 can be made to adequately adhere (to be more adhesive) to the ion-exchange membrane 15, and water retention by the ion-exchange membrane 15 can be increased. Advantageous conditions can therefore be assured for the reaction between the oxygen molecules and the hydrogen ions.

The concentration of the ion-exchange resin 31 is low in the third area E3, i.e., the region E3 in the vicinity of the boundary 16b with the cathode diffusion layer 18. For this reason, water generated by the reaction between the oxygen molecules, hydrogen ions, and electrons can be adequately discharged from the cathode 16 (drainage can be increased). The water flows from the cathode 16 to cathode diffusion layer 18.

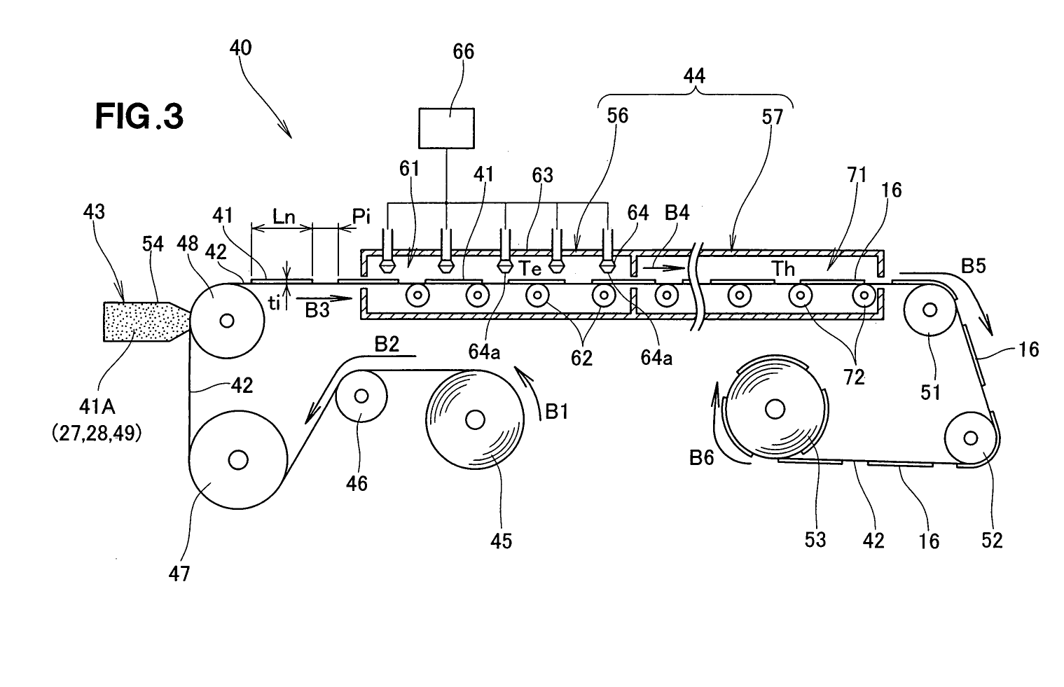

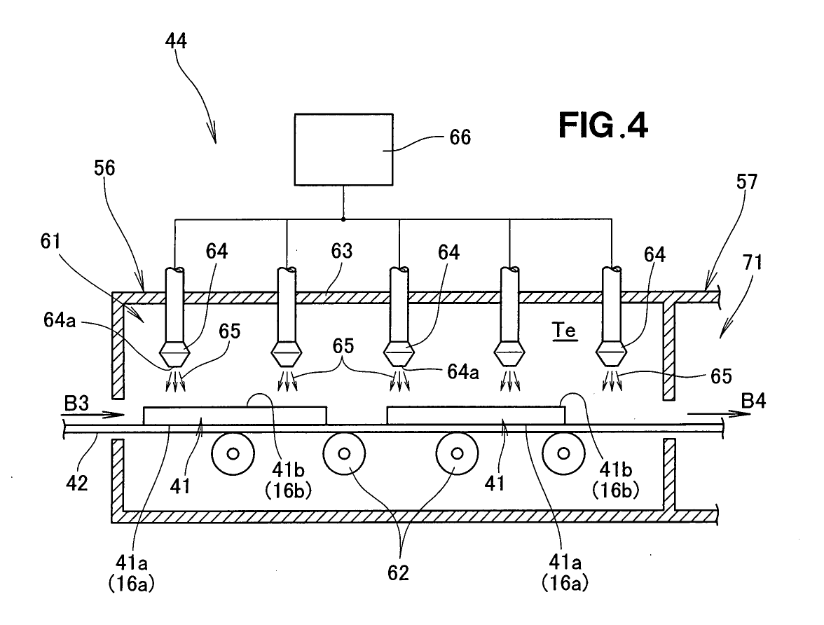

Next, the manufacturing device for manufacturing the cathode 16 (electrode layer 16 for a fuel cell) is described with reference to FIGS. 3 and 4.

FIG. 3 shows the entire configuration of a device 40 for manufacturing an electrode layer for a fuel cell. The manufacturing device 40 has an unwinding roller 45, a first transfer roller 46, a second transfer roller 47, a coating roller 48, a coating device 43 (application device 43), a drying device 44 with a concentration gradient, a third transfer roller 51, a fourth transfer roller 52, and a winding roller 53.

The unwinding roller 45 is an unwinding device whereby a wound base material 42 in the form of a sheet is unwound to the upstream side of the coating device 43 by way of the first transfer roller 46 and second transfer roller 47. The base material 42 is a flexible long sheet (including film) and is composed of a release liner obtained by subjecting paper, a resin sheet, or the like to a release treatment. The base material 42 may be the ion-exchange membrane 15 as such (see FIG. 2) in the form of a long sheet wound on the unwinding roller 45.

The coating device 43 is used to apply an electrode paste 41A to the long base material 42 guided by the coating roller 48. The coating device 43 is provided with a coater 54 for applying the electrode paste 41A to the base material 42.

The electrode paste 41A is a paste-form electrode material for the cathode 16. The paste comprises the particulate conductive material 27, pore-forming agent 28, and solvent 49. The solvent 49 is a liquid that evaporates (volatilizes) at normal temperature or higher and contains the ion-exchange resin 31 (see FIG. 2). The ion-exchange resin 31 comprises Nafion (registered trademark), for example.

A drying device 44 with a concentration gradient performs drying and imparts a gradient to the concentration of the ion-exchange resin 31 in the thickness direction of a layer 41 (hereinafter referred to as “electrode paste layer 41”) formed by the application of the electrode paste 41A to the base material 42, as shown in FIGS. 3 and 4. The drying device 44 with a concentration gradient is hereinafter simply referred to as “drying device 44.”

In the layer 41 obtained by applying the electrode paste to the base material 42, the surface 41a (first surface 41a) that faces the base material 42 will be referred to as “reverse surface 41a,” and the surface 41b (a second surface 41b) on the side opposite from the base material 42 will be referred to as “front surface 41b,” as shown in FIG. 4. The front surface 41b is the surface that corresponds to the boundary 16b with the cathode diffusion layer 18 shown in FIG. 2.

The drying device 44 has a concentration gradient chamber 56 for evaporating a prescribed amount of the solvent 49 from the surface 41b of the electrode paste layer 41, and a heating oven 57 (drying oven 57) for drying the electrode paste layer 41.

The basic constituent elements of the concentration gradient chamber 56 are a heating unit (not shown) for heating the chamber 61 to a prescribed temperature, a plurality of first transport rollers 62 for transporting the base material 42 in the chamber 61, a plurality of blow nozzles 64 mounted on the ceiling 63, and an air feed unit 66 for feeding air 65 (see FIG. 4) to the blow nozzles 64.

The blow nozzles 64 are arrayed at least in the direction in which the base material 42 is transported. The array of blow nozzles 64 is preferably set so that air 65 can be uniformly blown at the entire surface in the front surface 41b of the electrode paste layer 41. The blow ports 64a of the nozzles 64 are disposed in the compartment 61. Since the blow nozzles 64 are mounted facing downward, the blow ports 64a face the front surface 41b in the electrode paste layer 41 applied to the base material 42. The distance from the blow ports 64a to the front surface 41b of the electrode paste layer 41 is set to a prescribed constant value.

The heating oven 57 is provided with a heating unit (not shown) for heating the interior 71 to a prescribed temperature, and a second transport roller 72 for transporting the base material 42 in the interior 71, as shown in FIG. 3.

The winding roller 53 is a winding device for winding the base material 42 from the downstream side of the drying device 44 by way of the third and fourth transport rollers 51 and 52. The winding action of the winding roller 53 (including the winding timing and winding speed) is synchronized with the unwinding action of the unwinding roller 45.

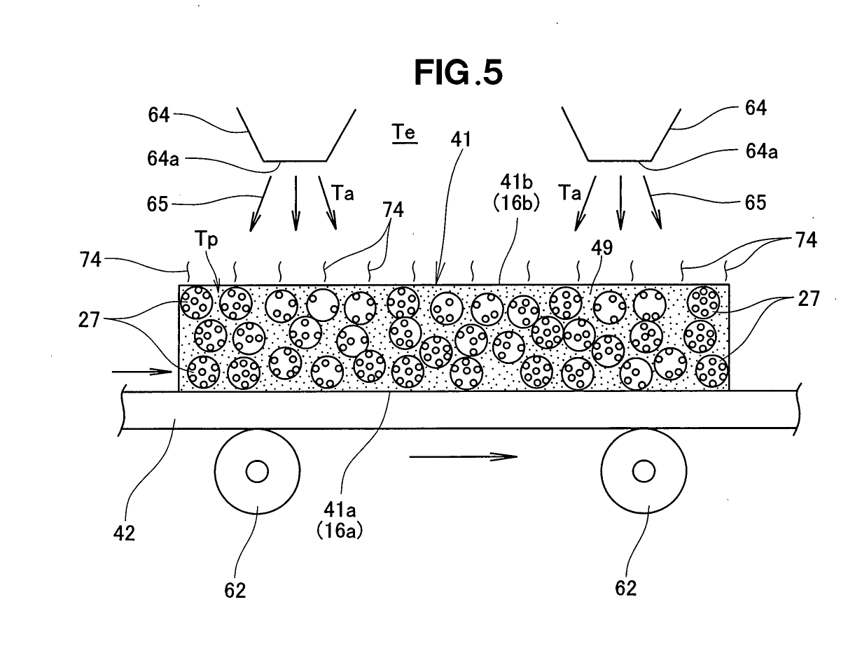

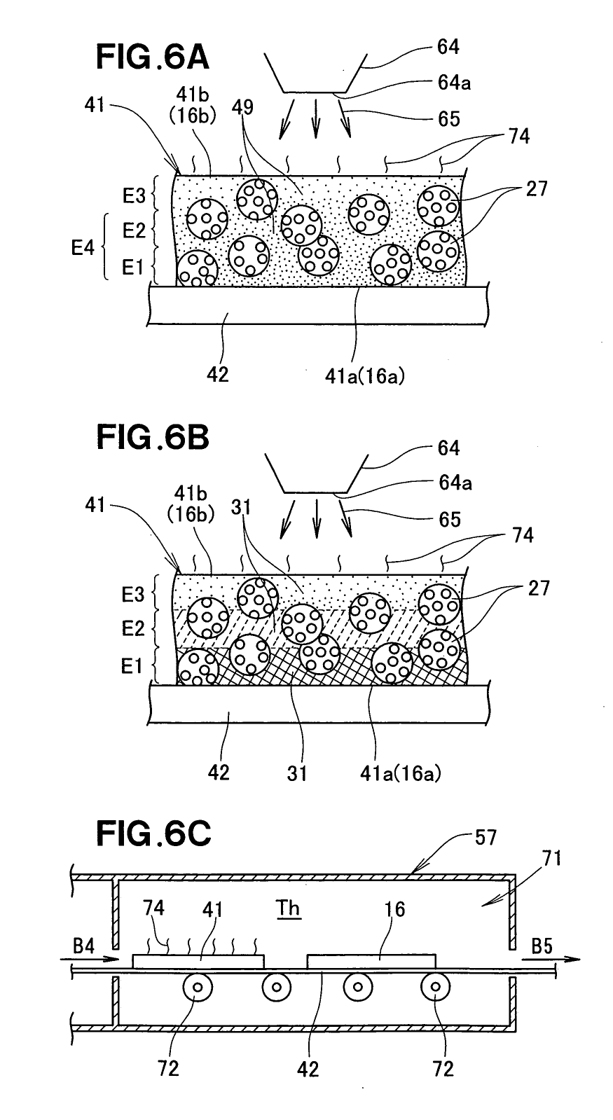

The method of manufacturing the cathode 16 (electrode layer 16 for a fuel cell) is described next with reference to FIGS. 3 to 6C. The pore-forming agent 28 is omitted from FIGS. 5 and 6A to 6C.

First step: In FIG. 3, a paste-form electrode material 41A, i.e., the electrode paste 41A is disposed on the coater 54 (electrode paste 41A preparation step). The electrode paste 41A contains a conductive material 27, a pore-forming agent 28, and a solvent 49. The solvent 49 contains an ion-exchange resin 31 (see FIG. 2).

Second step: The unwinding roller 45 and the winding roller 53 then rotate in synchronization (base material transport step). In other words, the unwinding roller 45 is rotated in the direction indicated by the arrow B1, and the base material 42 is unwound from the unwinding roller 45 in the manner indicated by the arrow B2. At the same time, the winding roller 53 is rotated in the direction indicated by the arrow B6, and the base material 42 is wound in the manner indicated by the arrow B5. The base material 42 unwound from the unwinding roller 45 is passed through the coating device 43 and the drying device 44 with a concentration gradient, and is then wound on the winding roller 53 by movement in the direction indicated by the arrows B2, B3, B4, and B5.

Third step: Next, electrode paste 41A is discharged from the coater 54 and applied to the base material 42 being guided by the coating roller 48 (coating step). At this point, the coater 54 coats the electrode paste 41A at prescribed intervals Pi on the base material 42 by intermittently discharging the electrode paste 41A. As a result, an electrode paste layer 41 with a constant coating length Ln and a constant thickness ti is formed on the long base material 42. The electrode paste layer 41 substantially uniformly contains the solvent 49 and ion-exchange resin 31. The electrode paste layer 41 also contains a pore-forming agent 28 in addition to the solvent 49 and ion-exchange resin 31. However, the pore-forming agent 28 is omitted from the description in order to simplify the understanding of the description.

Fourth step: Next, in FIG. 4, the base material 42 on which the electrode paste 41A has been coated is transported in the manner indicated by the arrow B3 into the chamber 61 of the concentration gradient chamber 56, and the concentration of the solvent 49 contained in the each electrode paste layer 41 is adjusted (concentration adjustment step).

More specifically, in the fourth step, the portion of the solvent 49 that is disposed on the front surface 41b and is contained in the layer 41 of the electrode paste (layer 41 of electrode material) applied to the base material 42 is evaporated so that the concentration of the ion-exchange resin 31 increases from the front surface 41b of the electrode paste layer 41 toward the reverse surface 41a on the side that faces the base material 42.

Following is a more detailed description of the fourth step.

The air in the chamber 61 in the concentration gradient chamber 56 is kept at a prescribed temperature Te, as shown in FIGS. 4 and 5. In other words, the chamber 61 is heated to a prescribed constant chamber temperature Te in advance using a heater. The chamber temperature Te is (1) a temperature that allows the solvent 49 contained in the electrode paste layer 41 to evaporate (volatilize), and (2) a temperature at which convection of the solvent 49 does not occur in the electrode paste layer 41. The chamber temperature is preferably set between 20 and 60° C.

Air 65 is blown from the blow ports 64a toward the upper surface of the base material 42 by being fed from the air feed unit 66 to the plurality of blow nozzles 64. The temperature Ta of the air 65 blown from the blow ports 64a is preferably set to between 10 and 40° C.

The base material 42 having a plurality of electrode paste layers 41 is transported into the chamber 61 of the concentration gradient chamber 56 managed in the manner described above. The electrode paste layers 41 are heated to a prescribed constant temperature Tp (about 20 to 60° C.) by transporting the electrode paste layers 41 in the chamber 61, which is kept at prescribed chamber temperature Te, as shown in FIGS. 4 and 5. In other words, the temperature of the electrode paste layers 41 is increased to a constant temperature Tp. Since the temperature of the chamber 61 is kept at a prescribed temperature Te, the upper-limit temperature of the electrode paste layers 41 is limited. For this reason, convection of the solvent 49 does not occur inside the electrode paste layers 41.

The electrode paste layers 41 are passed under the blow ports 64a in a sequential fashion. The blow nozzles 64 blow air 65 at the front surface 41b of the electrode paste layers 41. As a result, the solvent 49 contained in the electrode paste layer 41 evaporates from the front surface 41b to form vapor 74. The reverse surface 44b of the electrode paste layer 41 is in close contact with the base material 42. The solvent 49 does not evaporate (or substantially does not evaporate) from the reverse surface 44b. The evaporation time t1 of the solvent 49 is preferably set to three minutes. With the evaporation time t1 set to three minutes, the velocity (blow velocity) Sa with which air 65 is blown toward the front surface 41b of the electrode paste layers 41, and the transport velocity of the electrode paste layers 41 are adjusted so that the evaporation rate Rs of the solvent 49 is kept in a range of 23 to 66 wt % (23 to 66 wt %).

As used herein, the term “evaporation rate Rs (volatilization rate Rs) of the solvent” is a percentage (%) of the weight of the solvent 49 that has evaporated (volatilized) in the fourth step with respect to the weight of the solvent 49 contained in the electrode paste layer 41 immediately after application to the base material 42.

The concentration of the solvent 49 contained in the electrode paste layer 41 can be adjusted in the following manner by executing the fourth step.

For ease of description, the electrode paste layers 41 are considered as being divided into three layers, i.e., E1, E2, and E3, which are the three areas E1, E2, and E3, as shown in FIG. 6A. These areas E1, E2, and E3 correspond to the areas E1, E2, and E3 shown in FIG. 2 described above. The first area E1 is the portion of the electrode paste layer 41 that faces the base material 42 (the layer on the side of the reverse surface 41a). The second area E2 is the portion of the electrode paste layer 41 that is disposed between the first area E1 and the third area E3. The third area E3 is the portion of the electrode paste layer 41 on the side of the front surface 41b. The layer composed of the first and second areas E1 and E2 forms the fourth area E4.

The solvent 49 of the third area E3 on the side of the front surface 41b in the electrode paste layer 41 is evaporated as shown in FIG. 6A. The content of solvent 49 in the third area E3 decreases as a result. However, the ion-exchange resin 31 (see FIG. 6B) contained in the solvent 49 remains in the third area E3. The concentration of the ion-exchange resin 31 with respect to the content of solvent 49 increases in the third area E3.

The amount of evaporation of the solvent 49 in the fourth area E4 of the electrode paste layer 41 is low. In other words, the amount of evaporated solvent 49 is greatest in the third area E3 on the side of the front surface 41b and sequentially decreases in the second area E2 and first area E1. The concentration of ion-exchange resin 31 with respect to the remaining amount of solvent 49 is highest in the third area E3 on the side of the front surface 41b and sequentially decreases in the second area E2 and first area E1.

When the ion-exchange resin 31 contained in the solvent 49 has a difference in concentration, the ion-exchange resin 31 tends to form a uniform concentration and spreads (moves) from the high concentration side to the low concentration side. In other words, the ion-exchange resin 31 in the third area E3, which has the highest concentration, spreads toward the medium-concentration second area E2, and then to the low-concentration first area E1.

The content of the ion-exchange resin 31 in the front surface 41b is reduced when the ion-exchange resin 31 on the side of the front surface 41b spreads to the reverse surface 41a, and the content of the ion-exchange resin 31 in the side of the reverse surface 41a increases. As a result, the concentration of the ion-exchange resin 31 in the electrode paste layer 41 gradually increases from the front surface 41b toward the reverse surface 41a. In other words, the concentration of the ion-exchange resin 31 changes to a low concentration in the third area E3, to a medium concentration in the second area E2, and to a high concentration in the first area E1.

A concentration gradient can thus be created so that the concentration of the ion-exchange resin 31 in the electrode paste layer 41 increases from the front surface 41b to the reverse surface 41a.

Fifth step: Next, in FIG. 6C, the electrode paste layers 41 having the concentration gradient of the ion-exchange resin 31 are transported together with the base material 42 into the interior 71 of the heating oven 57 in the manner indicated by the arrow B4, the solvent 49 contained in the electrode paste layers 41 is evaporated, and the electrode paste layers 41 are solidified (solidifying step).

More specifically, in the fifth step, air in the interior 71 in the heating oven 57 is kept at a prescribed internal oven temperature Th. In other words, the oven interior 71 is heated in advance by a heater to a prescribed internal oven temperature Th. The internal oven temperature Th is the temperature of rapid evaporation of the solvent 49, and is preferably set at 100° C. Setting the internal oven temperature Th to 100° C. allows the electrode paste layers 41 to adequately dry. As a result, productivity can be increased because the drying time t2 of the electrode paste layers 41 can be shortened. Furthermore, since the internal oven temperature Th is held at 100° C., the electrode paste layer 41 is not heated more than necessary. For this reason, the cost of heating the heating oven 57 can be reduced.

The base material 42 having a plurality of electrode paste layers 41 is transported into the interior 71 of the heating oven 57 managed in this manner. The electrode paste layers 41 are heated to a prescribed constant temperature (about 100° C.) by transporting the electrode paste layers 41 through the interior 71, which is kept at a prescribed internal oven temperature Th. Specifically, the temperature of the electrode paste layers 41 is increased to a prescribed level.

All of the solvent 49 within the electrode paste layers 41 is evaporated by heating the electrode paste layers 41 to a prescribed temperature. The electrode paste layers 41 are dried (solidified), and the concentration gradient of the ion-exchange resin 31 is stabilized as a result. In this manner, cathodes 16 are obtained from the electrode paste layers 41.

Sixth step: The cathodes 16 are subsequently transported together with the base material 42 from the heating oven 57 in the manner indicated by the arrow B5.

Seventh step: In FIG. 3, the transported cathodes 16 are then wound on the winding roller 53 together with the base material 42 in the manner indicated by the arrow D6. Production of the cathodes 16 is thus completed.

The cathodes 16 wound together with the base material 42 on the winding roller 53 are peeled away from the base material 42 and laminated to other components in order to manufacture a cell 11. When the base material 42 is composed of a long ion-exchange membrane 15, the cell 11 can be manufactured by laminating other components in a state in which the cathodes 16 remain laminated to the ion-exchange membrane 15.

In accordance with the method for manufacturing a cathode 16 (electrode layer 16) described above, the solvent 49 on the front surface 41b of the electrode paste layer 41 is evaporated and removed prior to drying (solidifying) the electrode paste layer 41. Hence, the concentration of the ion-exchange resin 31 can be gradually increased in progression from the front surface 41b of the electrode paste layer 41 toward the reverse surface 41a. In this state, the concentration gradient of the ion-exchange resin 31 can be stabilized by drying the electrode paste layer 41 to form the cathode 16.

In this manner, a cathode 16 endowed with a concentration gradient in the ion-exchange resin 31 can be easily manufactured by using a simple manufacturing method in which the solvent 49 on the front surface 41b of the electrode paste layer 41 is evaporated prior to drying the electrode paste layer 41. Productivity of fuel cells 10 can thereby be improved.

The entire set of steps from the first to seventh steps can be continuously carried out by fully automated control.

In the fourth step, evaporation on the front surface 41b is accelerated by blowing air 65 on the front surface 41b of the electrode paste layer 41. For this reason, the solvent 49 on the front surface 41b is evaporated with good efficiency, and the time for removing the solvent 49 on the front surface 41b can be shortened. Since the cathode 16 can be manufactured in a short amount of time, productivity of fuel cells 10 can be further increased.

Following is an analysis of the settings used in the fourth step. The method for analyzing the settings entails measuring the ion-exchange resin weight PE and the carbon weight C contained in the cathode 16, and calculating the optimum values on the basis of the measurement results.

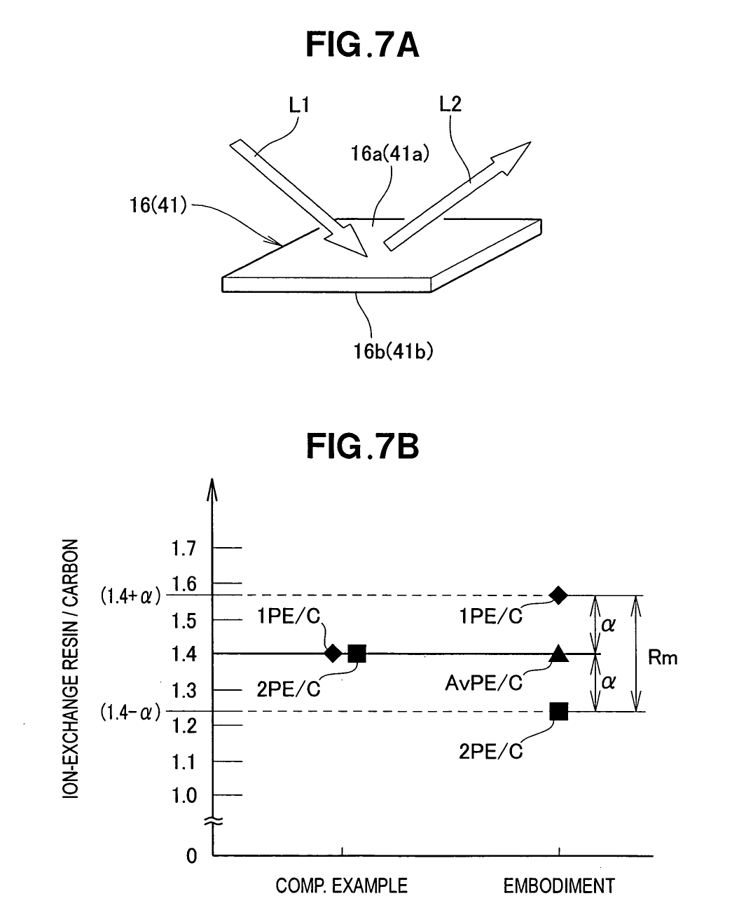

FIG. 7A summarizes the method for measuring the ratio of carbon and ion-exchange resin in the cathode 16.

In FIG. 7A, the boundary 16a with the ion-exchange membrane 15 of the cathode 16 will be referred to as “ion-exchange membrane boundary 16a.” The ion-exchange membrane boundary 16a is a surface that corresponds to the reverse surface 41a of the electrode paste layer 41 shown in FIG. 6B. The boundary with the cathode diffusion layer 18 (see FIG. 2) will be referred to as the “diffusion layer boundary 16b.” The diffusion layer boundary 16b is a surface that corresponds to the front surface 41b of the electrode paste layer 41.

The ratio PE/C of the ion-exchange resin weight PE to the carbon weight C at the ion-exchange membrane boundary 16a will be referred to as the “first ion-exchange resin/carbon ratio (1PE/C).” The ratio PE/C of the ion-exchange resin weight PE to the carbon weight C at the diffusion layer boundary 16b will be referred to as the “second ion-exchange resin/carbon ratio (2PE/C).”

A fluorescent X-ray spectroscope was used to calculate the first ion-exchange resin/carbon ratio 1PE/C and second ion-exchange resin/carbon ratio 2PE/C. The fluorescent X-ray spectroscope was a known device for irradiating test materials with X-rays; separating, analyzing, and recording the generated fluorescent X-rays (secondary X-rays) using spectroscopic crystals; and analyzing the elemental components.

In FIG. 7A, when the ion-exchange membrane boundary 16a of the cathode 16 is irradiated with X-rays having a constant wavelength in the manner indicated by the arrow L1, fluorescent X-rays are emitted from the ion-exchange membrane boundary 16a as indicated by the arrow L2. The spectrum of fluorescent X-rays is measured using spectrographic crystals. The ratio of the weight of the ion-exchange resin to the weight of carbon in the ion-exchange membrane boundary 16a side is calculated based on the measured values thus obtained.

Following is a specific description of the manner in which the first ion-exchange resin/carbon ratio 1PE/C is calculated.

First, the amount of elemental sulfur (S amount) of the sulfonic group contained in the ion-exchange resin and the amount of platinum catalyst (Pt amount) supported on the particulate carbon is measured in the ion-exchange membrane boundary 16a of the cathode 16 using a fluorescent X-ray spectroscope.

The weights of the ion-exchange resin and carbon at the ion-exchange membrane boundary 16a are then calculated based on the S and Pt amounts thus measured.

Lastly, the ratio 1PE/C of the weight of the ion-exchange resin to the weight of the carbon, i.e., the first ion-exchange resin/carbon ratio 1PE/C is calculated.

The second ion-exchange resin/carbon ratio 2PE/C is calculated in the following manner.

First, the amount of elemental sulfur (S amount) of the sulfonic group contained in the ion-exchange resin and the amount of platinum catalyst (Pt amount) supported on the particulate carbon is measured at the diffusion layer boundary 16b of the cathode 16 using a fluorescent X-ray spectroscope in the same manner as in the method for calculating the first ion-exchange resin/carbon ratio 1PE/C.

The weights of the ion-exchange resin and carbon at the diffusion layer boundary 16b are then calculated based on the S and Pt amounts thus measured.

Lastly, the ratio 2PE/C of the weight of the ion-exchange resin to the weight of the carbon, i.e., the second ion-exchange resin/carbon ratio 2PE/C is calculated.

Analysis of the settings was carried out by preparing cathodes according to the examples and comparative examples, and investigating the differences. FIG. 7B shows the ion-exchange resin/carbon ratio on the vertical axis, and the examples and comparative examples on the horizontal axis.

The cathode of the comparative example is a sample obtained by applying electrode paste 41A (see FIG. 3) to a base material 42 (see FIG. 3) and solidifying the paste by drying while the ion-exchange resin/carbon ratio is set to 1.4 across the entire electrode paste 41A. In other words, the cathode of the comparative example was manufactured without using the fourth step described above. The first and second ion-exchange resin/carbon ratios in the solidified cathode of the comparative example were determined by the measurement method described above.

The results are shown in FIG. 7B. According to these results, the first ion-exchange resin/carbon ratio 1PE/C in the cathode of the comparative example was 1.4 as indicated by the ♦ mark, and the second ion-exchange resin/carbon ratio 2PE/C in the cathode was 1.4 as indicated by the ▪ mark. In other words, in the cathode of the comparative example, the 1PE/C and the 2PE/C have the same value, making it apparent that the weight of the ion-exchange resin at the ion-exchange membrane boundary and the weight of the ion-exchange resin at the cathode diffusion layer boundary are the same.

The cathode 16 of the examples is a sample manufactured using the manufacturing method shown in FIGS. 3 to 6C. In other words, the sample in the examples was obtained by applying electrode paste 41A to a base material 42 and carrying out the fourth and fifth steps while the ion-exchange resin/carbon ratio was set to 1.4 across the entire electrode paste 41A.

The results are shown in FIG. 7B. According to these results, the first ion-exchange resin/carbon ratio 1PE/C in the cathode of the examples was “1.4+α” as indicated by the ♦ mark, and the second ion-exchange resin/carbon ratio 2PE/C in the cathode was “1.4−α” as indicated by the ▪ mark. The average value AvPE/C of the 1PE/C and 2PE/C is 1.4, as indicated by the ▴ mark. The weight of the ion-exchange resin at the ion-exchange membrane boundary 16a in the cathode 16 of the examples is thus increased and the weight of the ion-exchange resin at the cathode diffusion layer boundary 16b is reduced. In other words, the cathode 16 of the examples is endowed with a concentration gradient so that the content of ion-exchange resin gradually increases from the diffusion layer boundary 16b toward the ion-exchange membrane boundary 16a.

The concentration gradient of the ion-exchange resin is related to the difference Rm between the 1PE/C and 2PE/C, i.e., the difference Rm in the ion-exchange resin/carbon ratio. When the value of Rm is considerable, the concentration gradient of the ion-exchange resin is high. When the value of the Rm is low, the concentration gradient of the ion-exchange resin is also low. The value of Rm is calculated using the following equation.
Rm=2×α=2×(1.4−2PE/C)

As a result of the above, it was confirmed that the cathode 16 of the examples obtained by carrying out the fourth step can be endowed with a considerable ion-exchange resin concentration gradient.

It is known from experience that the value of Rm is preferably set to a range of 0.2 to 0.6 (0.2≦Rm≦0.6).

The reason for this is that the content of ion-exchange resin at the ion-exchange membrane boundary 16a can be appropriately increased by setting the value of Rm to a level at or above 0.2. For this reason, all of the following three conditions can be satisfied. First, adhesion of the ion-exchange membrane boundary 16a to the ion-exchange membrane 15 is increased. Second, the moisture retention of the ion-exchange membrane boundary 16a side is increased. Third, the water generated in the cathode 16 can be adequately discharged from the diffusion layer boundary 16b. The reaction efficiency in the vicinity of the ion-exchange membrane boundary 16a in the cathode 16 can be increased.

When the value of Rm is set above 0.6, it is believed that the content of ion-exchange resin at the ion-exchange membrane boundary 16a becomes excessively high and results in enhanced resistance. In other words, oxygen molecules and hydrogen ions experience greater difficulty in passing through the portion of the cathode 16 that faces the ion-exchange membrane boundary 16a.

For this reason, the value of Rm is preferably set within a range of 0.2 to 0.6.

Next, in the fourth step, the settings that affect keeping the value of Rm within the range of 0.2 to 0.6 are determined by carrying out the following experiment. Possible settings include the blow velocity Sa of the air 65, the evaporation time t1 of the solvent 49, and the chamber temperature Te of the concentration gradient chamber 56 shown in FIG. 3. The experimental examples are described below with reference to FIGS. 4 to 6C.

Experiment 1 was carried out first, and the effect of the evaporation time t1 of the solvent 49 was studied. Specifically, in experiment 1, the electrode paste layer 41 was held in the concentration gradient chamber 56 (see FIG. 3). The conditions of experiment 1 are shown in TABLE 1 below.

TABLE 1

| Concentration adjustment step | | | Solidifying step | |
|---|---|---|---|---|
| Chamber | Blow | Evaporation | Internal oven | |
| temperature | velocity | time t1 | temperature | Drying time |
| Te (° C.) | Sa (m/s) | (min) | Th (° C.) | t2 (min) |
| 23 | 0 | 1 | 100 | 5 |
| | | 5 | | |
| | | 10 | | |
| | | 30 | | |
| | | 60 | | |

The electrode paste layer 41 was held in the chamber 61 of the concentration gradient chamber 56 for a holding time t1 under experimental conditions that corresponded to a chamber temperature Te of 23° C. while the blowing of air 65 was stopped (blow velocity Sa of air 65: 0 m/s), as shown in TABLE 1. The holding time t1 corresponds to the time t1 in which the solvent 49 is evaporated. Hereinbelow, the holding time t1 will be referred to as “evaporation time t1.” After the evaporation time t1 had elapsed, the electrode paste layer 41 was dried for 5 minutes in the heating oven 57. The interior temperature Th of the heating oven 57 was 100° C.

In experiment 1, the evaporation time t1 was set to five time intervals, i.e., 1 minute, 5 minutes, 10 minutes, 30 minutes, and 60 minutes, and the second ion-exchange resin/carbon ratio was studied as relates to the differences in the evaporation time t1.

The electrode paste layer 41 had an ion-exchange resin/carbon ratio of 1.4 immediately after being applied to the base material 42, and the ratio was uniform over the entire area of the electrode paste layer 41.

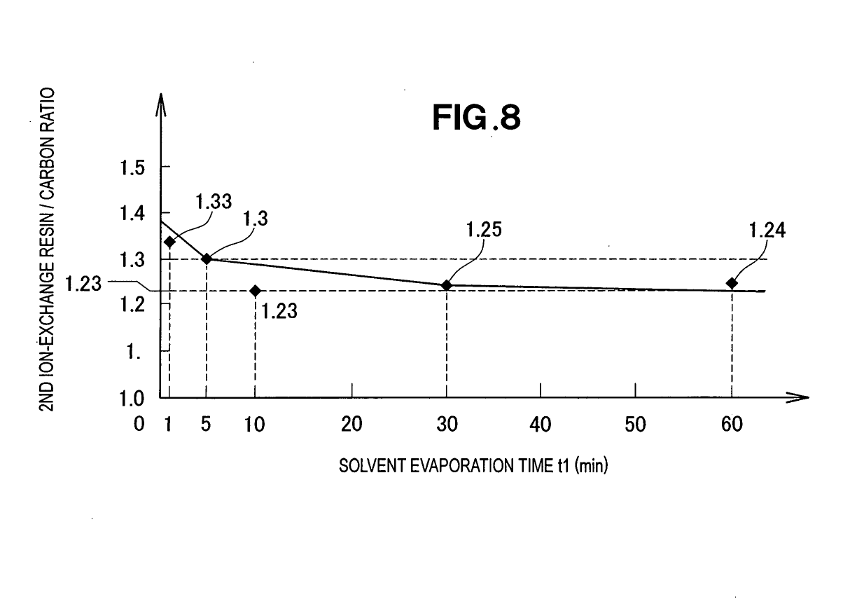

The results of experiment 1 are shown in the graph in FIG. 8. FIG. 8 shows the relationship between the second ion-exchange resin/carbon ratio with respect to the evaporation time t1, wherein the evaporation time t1 of the solvent 49 is plotted on the horizontal axis, and the second ion-exchange resin/carbon ratio is plotted on the vertical axis. The experimental results are indicated by ♦ marks.

According to FIG. 8, when the evaporation time t1 was 1 minute, the second ion-exchange resin/carbon ratio 2PE/C was 1.33. As described above, the average value of the first ion-exchange resin/carbon ratio 1PE/C and second ion-exchange resin/carbon ratio 2PE/C was 1.4 immediately after coating. For this reason, the value of Rm was calculated as follows.
Rm=2×(1.4−1.33)=0.14

Hence, the value of Rm was less than 0.2 when the evaporation time t1 was 1 minute, and a concentration gradient could not be suitably imparted to the ion-exchange resin 31.

When the evaporation time t1 was 5 minutes, 2PE/C was 1.3. The value of Rm was therefore calculated as follows.
Rm=2×(1.4−1.3)=0.2

Therefore, 0.2≦Rm<0.6 when the evaporation time t1 was 5 minutes, and a suitable concentration gradient was imparted to the ion-exchange resin 31.

When the evaporation time t1 was 10 minutes, 2PE/C was 1.23. The value of Rm was therefore calculated as follows.
Rm=2×(1.4−1.23)=0.34

Therefore, 0.2<Rm<0.6 when the evaporation time t1 was 10 minutes, and a suitable concentration gradient was imparted to the ion-exchange resin 31.

When the evaporation time t1 was 30 minutes, 2PE/C was 1.25. The value of Rm was therefore calculated as follows.
Rm=2×(1.4−1.25)=0.3

Therefore, 0.2<Rm<0.6 when the evaporation time t1 was 30 minutes, and a suitable concentration gradient was imparted to the ion-exchange resin 31.

When the evaporation time t1 was 60 minutes, 2PE/C was 1.24. The value of Rm was therefore calculated as follows.
Rm=2×(1.4−1.24)=0.32

Therefore, 0.2<Rm<0.6 when the evaporation time t1 was 60 minutes, and a suitable concentration gradient was imparted to the ion-exchange resin 31.

Characteristics similar to the experiment results indicated by the ♦ marks are represented by solid lines in FIG. 8.

Based on the above-described equation RM=2×(1.4−2PE/C), the value of 2PE/C must be kept to 1.3 or less (2PE/C≦1.3) in order to satisfy the condition that 0.2≦Rm. According to FIG. 8, the evaporation time t1 was 5 minutes when 2PE/C is set to 1.3.

Also, according to FIG. 8, when the evaporation time t1 of the solvent 49 was 10 minutes, the value of 2PE/C was 1.23, the lowest value. For this reason, it is apparent from experiment 1 that the evaporation time t1 should be set to 10 minutes or greater when the air 65 is not blown at the paste. Reaction efficiency in the vicinity of the ion-exchange membrane boundary 16a will even more enhanced in the cathode 16 by setting the evaporation time t1 to 10 minutes or greater.

Next, experiment 2 was carried out to study the effect of the chamber temperature Te of the concentration gradient chamber 56. The chamber temperature Te corresponds to the temperature Te at which the solvent 49 is evaporated. The chamber temperature Te will hereinafter be referred to as the “evaporation temperature Te.”

The conditions of experiment 2 entailed varying the evaporation temperature Te in the chamber 61 of the concentration gradient chamber 56 while the blowing of air 65 was stopped (blow velocity Sa of air 65: 0 m/s), and the electrode paste layer 41 was held in the chamber for a holding time t1 of 60 minutes. The holding time t1 corresponds to the time t1 in which the solvent 49 is evaporated. Hereinbelow, the holding time t1 will be referred to as the “evaporation time t1.” The electrode paste layer 41 was dried for 5 minutes in the heating oven 57. The internal temperature Th of the heating oven 57 was 100° C.

In experiment 2, the evaporation temperature Te was set at seven temperature levels, i.e., 10° C., 20° C., 30° C., 40° C., 50° C., 60° C., and 70° C., and the second ion-exchange resin/carbon ratio was studied as relates to the differences in the evaporation temperature Te.

The electrode paste layer 41 had an ion-exchange resin/carbon ratio of 1.4 immediately after being applied to the base material 42, and the ratio was uniform over the entire area of the electrode paste layer 41.

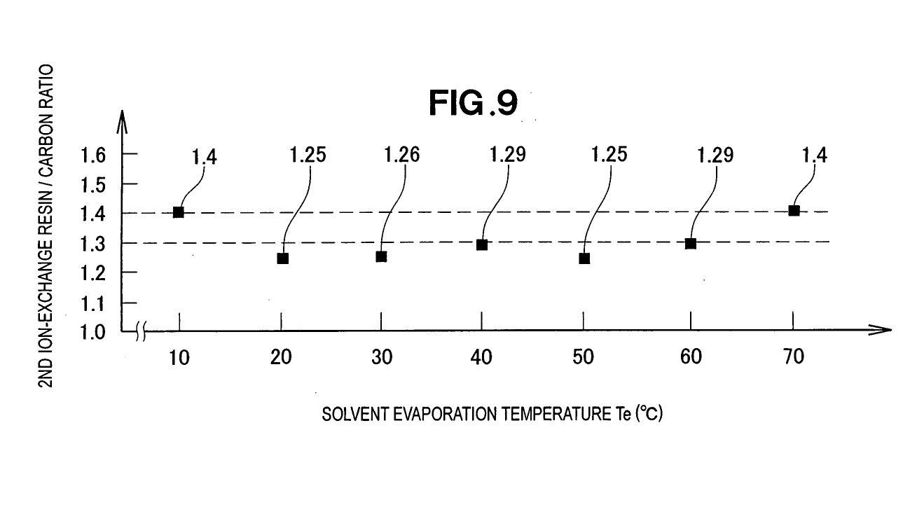

The results of experiment 2 are shown in the graph in FIG. 9. FIG. 9 shows the relationship between the second ion-exchange resin/carbon ratio with respect to the evaporation temperature Te, wherein the evaporation temperature Te of the solvent 49 is plotted on the horizontal axis, and the second ion-exchange resin/carbon ratio is plotted on the vertical axis. The experimental results are indicated by ▪ marks.

According to FIG. 9, when the evaporation temperature Te was 10° C., the second ion-exchange resin/carbon ratio 2PE/C was 1.40. In a similar fashion, 2PE/C was 1.25 when Te was 20° C., 2PE/C was 1.26 when Te was 30° C., 2PE/C was 1.29 when Te was 40° C., 2PE/C was 1.25 when Te was 50° C., 2PE/C was 1.29 when Te was 60° C., and 2PE/C was 1.40 when Te was 70° C.

It is apparent in the experiment results shown in FIG. 9 that the evaporation temperature Te of the solvent 49 is preferably set within a range of 20 to 60° C. in order to satisfy the condition that 2PE/C≦1.3.

When the evaporation temperature Te is less than 20° C., it is difficult to adequately evaporate the solvent 49 from the front surface 41b of the electrode paste layer 41. For this reason, 2PE/C cannot be 1.3 or less. When the evaporation temperature Te exceeds 60° C., the evaporation rate of the solvent 49 is too great. For this reason, the entire electrode paste layer 41 dries before a concentration gradient is imparted to the ion-exchange resin 31, and 2PE/C cannot be made 1.30 or less.

Next, experiment 3 was carried out to study the effect of the blow velocity Sa of the air 65. Specifically, experiment 3 entailed holding the electrode paste layer 41 in the concentration gradient chamber 56 (see FIG. 3) for a fixed holding time t1. The holding time t1 corresponds to the time t1 in which the solvent 49 is evaporated. Hereinbelow, the holding time t1 will therefore be referred to as “evaporation time t1.” The conditions of experiment 3 are shown in TABLE 2.

TABLE 2

| Concentration adjustment step | | | Solidifying step | |
|---|---|---|---|---|
| Chamber | Blow | Evaporation | Internal oven | |
| temperature | velocity | time t1 | temperature | Drying time |
| Te (° C.) | Sa (m/s) | (min) | Th (° C.) | t2 (min) |
| 23 | 0 | 3 | 100 | 2 |
| | 0.18 | | | |
| | 0.5 | | | |
| | 1.0 | | | |
| | 1.5 | | | |
| | 2.0 | | | |
| | 2.5 | | | |
| | 3.0 | | | |

The electrode paste layer was held in the chamber 61 of the concentration gradient chamber 56 while the blow velocity Sa of the air 65 was varied under experimental conditions that corresponded to a chamber temperature Te of 23° C. and a solvent 49 evaporation time t1 (holding time t1) of three minutes, as shown in TABLE 2. The temperature of the air 65 was 23° C. After the evaporation time t1 had elapsed, the electrode paste layer 41 was dried for two minutes in the heating oven 57 (drying time t2=2 minutes). The internal temperature Th of the heating oven 57 was 100° C. In contrast to the evaporation time t1 of 3.5 minutes and a drying time t2 of 5 minutes in experiment 1 described above, the evaporation time t1 and drying time t2 were short in experiment example 3.

In experiment 3, the velocity Sa (wind velocity) with which air 65 was blown toward the front surface 41b of the electrode paste 41 was set to seven velocities, i.e., 0 m/s (seconds), 0.18 m/s, 0.5 m/s, 1.0 m/s, 1.5 m/s, 2.0 m/s, 2.5 m/s, and 3.0 m/s, and the second ion-exchange resin/carbon ratio was studied as relates to the differences in the blow velocity Sa.

The electrode paste layer 41 had an ion-exchange resin/carbon ratio of 1.4 immediately after being applied to the base material 42, and the ratio was uniform over the entire area of the electrode paste layer 41.

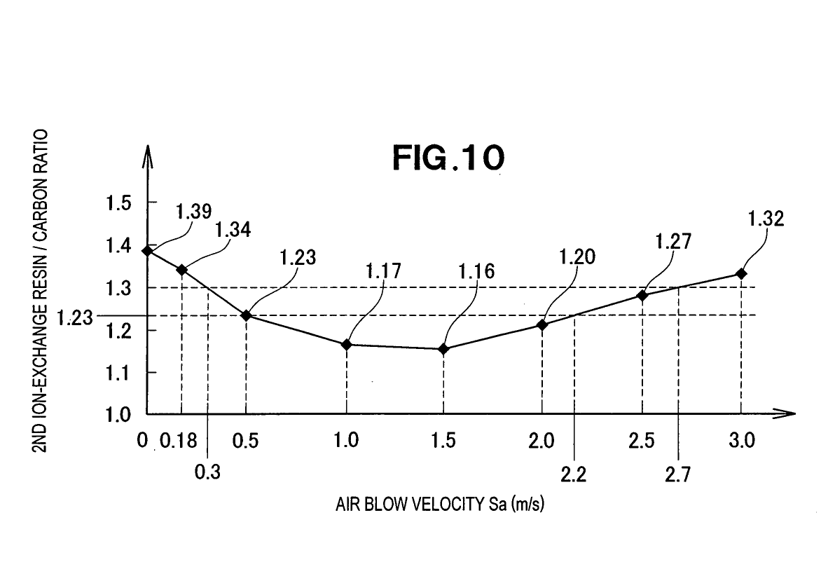

The results of experiment 3 are shown in the graph in FIG. 10. FIG. 10 shows the relationship of the second ion-exchange resin/carbon ratio with respect to the blow velocity Sa of the air 65, wherein the blow velocity Sa is plotted on the horizontal axis, and the second ion-exchange resin/carbon ratio is plotted on the vertical axis. The experiment results are indicated by ♦ marks.

According to FIG. 10, when the blow velocity Sa was 0 m/s, the second ion-exchange resin/carbon ratio 2PE/C was 1.39. In a similar fashion, 2PE/C was 1.34 when Sa was 0.18 m/s, 2PE/C was 1.23 when Sa was 0.5 m/s, 2PE/C was 1.17 when Sa was 1.0 m/s, 2PE/C was 1.16 when Sa was 1.5 m/s, 2PE/C was 1.20 when Sa was 2.0 m/s, 2PE/C was 1.27 when Sa was 2.5 m/s, and 2PE/C was 1.32 when Sa was 3.0 m/s.

Characteristics similar to the experimental results indicated by the ♦ marks are represented by solid lines in FIG. 10.

In accordance with the results of experiment 3 shown in FIG. 10, 2PE/C exceeded 1.3 when the blow velocity Sa was 0 m/s, 0.18 m/s, and 3.0 m/s, and it was therefore impossible to impart a suitable concentration gradient to the ion-exchange resin 31. On the other hand, since 2PE/C was 1.3 or less when the blow velocity Sa was 0.5 m/s, 1.0 m/s, 1.5 m/s, 2.0 m/s, and 2.5 m/s, a suitable concentration gradient was imparted to the ion-exchange resin 31. It is therefore apparent that the blow velocity Sa must be 0.3 to 2.7 m/s in order keep the 2PE/C≦1.3.

In other words, when the blow velocity Sa is less than 0.3 m/s, it is difficult to adequately evaporate the solvent 49 from the front surface 41b of the electrode paste layer 41. For this reason, 2PE/C cannot be 1.3 or less. When the blow velocity Sa exceeds 2.7 m/s, the evaporation rate of the solvent 49 is too great. For this reason, the entire electrode paste layer 41 dries before a concentration gradient is imparted to the ion-exchange resin 31, and 2PE/C cannot be made 1.3 or less.

However, in experiment 3, setting 2PE/to 1.23 or less in the same manner as experiment 1 makes it possible to further improve the reaction efficiency in the vicinity of the ion-exchange membrane boundary 16a in the cathode 16. The blow velocity Sa must be in a range of 0.5 m/s to 2.2 m/s in order to keep 2PE/C at 1.23 or less.

As described above, the evaporation time t1 of the solvent 49 can be kept short, e.g., 3 minutes by blowing air 65 at the front surface 41b of the electrode paste 41. Also, the drying time t2 of the heating oven 57 is also kept short, e.g., 2 minutes. The cathode 16 can be manufactured in a short period of time, and productivity of fuel cells can be further improved in comparison with experiment 1 by reducing the evaporation time t1 and drying time t2.

In experiment 3, the temperature of the air 65 was set to 23° C., but the temperature may be selected within a range of 10° C. to 40° C. When the evaporation temperature Te is less than 10° C., it is difficult to suitably evaporate the solvent 49 from the front surface 41b of the electrode paste layer 41. For this reason, time is required to evaporate the solvent 49. Conversely, when the evaporation temperature Te exceeds 40° C., the evaporation rate of the solvent 49 from the front surface 41b of the electrode paste layer 41 becomes too great. For this reason, the entire electrode paste layer 41 dries before a concentration gradient is imparted to the ion-exchange resin 31, and 2PE/C cannot be made 1.3 or less.

Next, experiment 4 was carried out to study the effect of the evaporation time t1 of the solvent 49 on the evaporation rate Rs of the solvent 49. Specifically, experiment 4 entailed holding the electrode paste layer 41 in the concentration gradient chamber 56 (see FIG. 3) for a fixed holding time t1. The holding time t1 corresponds to the time t1 in which the solvent 49 is evaporated. Hereinbelow, the holding time t1 will therefore be referred to as “evaporation time t1.”

As used herein, the term “evaporation rate Rs of the solvent” is a percentage (%) of the weight of the solvent 49 that has evaporated (volatilized) in the fourth step with respect to the weight of the solvent 49 contained in the electrode paste layer 41 immediately after application to the base material 42.

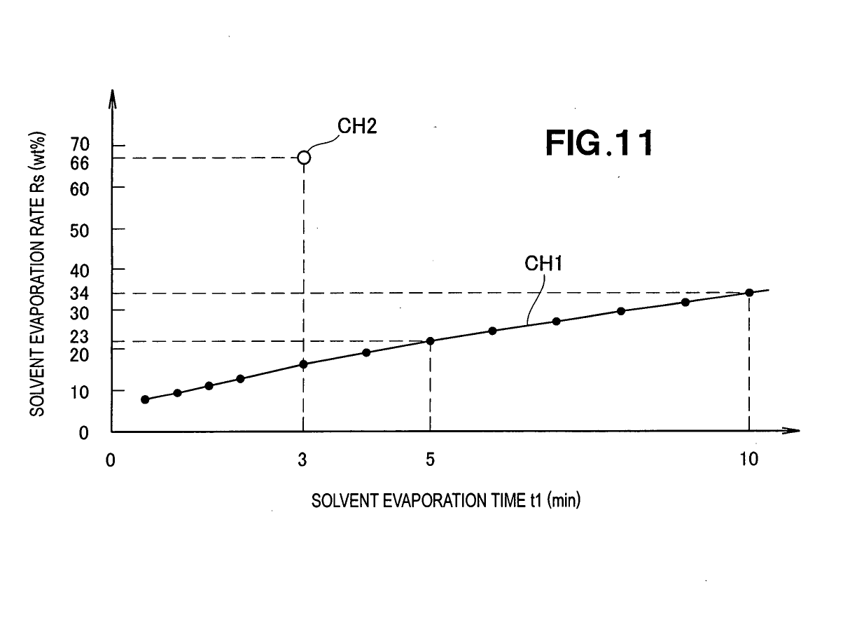

The results of experiment 4 are shown in the graph in FIG. 11. FIG. 11 shows the relationship between the evaporation rate Rs and the evaporation time, wherein the evaporation time t1 (minutes) of the solvent 49 is plotted on the horizontal axis, and the evaporation rate Rs of the solvent 49 is plotted on the vertical axis.

In FIG. 11, the first characteristic curve CH1 indicated by the ● marks and the solid line shows the characteristics of the electrode paste layer 41 tested using a first set of conditions. The second characteristic point CH2 indicated by the ∘ marks show the characteristics of the electrode paste layer 41 tested using a second set of conditions.

The first and second sets of conditions shared the following points. Specifically, the solvent 49 was evaporated by holding the electrode paste layer 41 in the chamber 61 for a fixed evaporation time t1 (holding time t1) at a chamber temperature Te of 23° C. After the evaporation time t1 elapsed, the electrode paste layer 41 was dried for two minutes in the drying oven 57 (drying time t2=2 minutes). The internal temperature Th of the heating oven 57 was 100° C.

The first set of conditions roughly corresponds to experiment 1 shown in FIG. 8. In other words, in the first set of conditions, blowing of air 65 at the front surface 41b of the electrode paste layer 41 was stopped (blow velocity Sa of air 65: 0 m/s).

In the second set of conditions, air 65 was blown at the front surface 41b of the electrode paste layer 41. The blow velocity Sa of the air 65 was 1.5 m/s, the temperature of the air 65 was 23° C., and the evaporation time t1 was 3 minutes.

According to the first characteristic curve CH1, the evaporation rate Rs of the solvent 49 was 34 wt % when the evaporation time t1 was set to 10 minutes, as shown in FIG. 11. The value of 2PE/C was 1.23 when the electrode paste layer 41 was held in the chamber 61 for 10 minutes at a chamber temperature of 23° C., as shown in FIG. 8. Based on this fact, it is apparent that the value of 2PE/C is 1.23 when the evaporation rate Rs of the solvent 49 in the electrode paste layer 41 is 34 wt %.

According to the first characteristic curve CH1, the evaporation rate Rs of the solvent 49 was 23 wt % when the evaporation time t1 was set to 5 minutes. The value of 2PE/C was 1.3 when the electrode paste layer 41 was held in the chamber 61 for 5 minutes at a chamber temperature of 23° C., as shown in FIG. 8. Based on this fact, it is apparent that the value of 2PE/C is 1.3 when the evaporation rate Rs of the solvent 49 in the electrode paste layer 41 is 23 wt %.

On the other hand, according to the second characteristic point CH2, the evaporation rate Rs of the solvent 49 in the electrode paste layer 41 was 66 wt % when the air 65 was blown for 3 minutes at a blow velocity Sa of 1.5 m/s. The value of 2PE/C was 1.16 when the air 65 was blown at the front surface 41b of the electrode paste 41 at a blow velocity Sa of 1.5 m/s. Based on this fact, it is apparent that the value of 2PE/C is 1.3 when the evaporation rate Rs of the solvent 49 in the electrode paste layer 41 66 23 wt %.

The above discussion is summarized below.

As described above, a suitable concentration gradient can be imparted to the ion-exchange resin 31 by setting the value of Rm to a range of 0.2 to 0.6.

Based on the equation RM=2×(1.4−2PE/C), the value of 2PE/C must be kept to 1.3 in order to make Rm=0.2. In other words, 1PE/C is 1.5 and Rm is 0.2 when 2PE/C=1.3. The evaporation rate Rs must be 23 wt % in order for 2PE/C to be equal to 1.3.

On the other hand, based on the equation RM=2×(1.4−2PE/C), the value of 2PE/C must be kept to 1.1 in order to make Rm=0.6. In other words, 1PE/C is 1.7 and Rm is 0.6 when 2PE/C=1.1. The evaporation rate Rs must be 66 wt % in order for 2PE/C to be equal to 1.1.

When the evaporation rate Rs is less than 23 wt %, it is difficult to increase the concentration of the ion-exchange resin 31 on the front surface 41b of the electrode paste layer 41 to a prescribed concentration during the evaporation of the solvent 49. For this reason, the difference between the concentration of the ion-exchange resin 31 on the front surface 41b and the concentration of the ion-exchange resin 31 on the reverse surface 41a cannot be adequately assured, and the ion-exchange resin 31 on the front surface 41b therefore fails to spread to the reverse surface 41a. In view of the above, the evaporation rate Rs is set to 23 wt % or higher and the concentration of the ion-exchange resin 31 on the front surface 41b is increased to a prescribed concentration in order to adequately assure the difference between the concentration of the ion-exchange resin 31 on the front surface 41b and the concentration of the ion-exchange resin 31 on the reverse surface 41a. The ion-exchange resin 31 of the front surface 41b can be moved to the reverse surface 41a, and a suitable concentration gradient can be imparted to the ion-exchange resin 31.

Conversely, when the evaporation rate Rs exceeds 66 wt %, the ion-exchange resin 31 on the front surface 41b moves excessively to the reverse surface 41a, and resistance is believed to increase as a result. In view of the above, the evaporation rate Rs is set to 66 wt % or less, and the ion-exchange resin 31 on the front surface 41b side is allowed to move in an appropriate manner to the reverse surface 41a. A suitable concentration gradient can be imparted to the ion-exchange resin 31 by causing the ion-exchange resin 31 of the front surface 41b to spread in an appropriate manner to the reverse surface 41a.

The value of Rm can be set to a range of 0.2 to 0.6 by setting the evaporation rate Rs to a range of 23 to 66 wt % in this manner.

The evaporation rate Rs can be set to 23 wt % or higher by setting the evaporation time t1 of the solvent 49 to 5 minutes or longer in the case that the solvent 49 is evaporated solely by allowing the electrode paste 41 to stand (without blowing air 65). A concentration gradient can be suitably imparted to the ion-exchange resin 31 because the evaporation time t1 can be assured to be relatively long, i.e., 5 minutes or longer.

When the electrode paste layer 41 is held in the chamber at a chamber temperature of 23° C. and the solvent 49 is evaporated by blowing air 65 on the front surface 41b of the electrode paste 41, the evaporation rate Rs can be set in a range of 23 to 66 wt % with a relatively short evaporation time t1 for the solvent 49. However, when the evaporation time t1 of the solvent 49 is excessively short, the electrode paste 41 dries before a concentration gradient is imparted to the ion-exchange resin 31, and it is difficult to keep 2PE/C at 1.3 or less.

For this reason, the evaporation time t1 of the solvent 49 is preferably set to 3 minutes. In other words, with the evaporation time t1 of the solvent 49 set to 3 minutes, the blow velocity Sa of the air 65 is adjusted to 1.5 m/s so that the evaporation rate Rs is in a range of 23 to 66 wt %. A concentration gradient can thereby be suitably imparted to the ion-exchange resin 31, and the 2PE/C can be set to 1.3 or less.

In the present invention, the cathode 16 was described as an example of an electrode layer for a fuel cell, but no limitation is imposed thereby, and the electrode layer may be an anode 17.

In the present invention, an example of applying an electrode paste 41 to a base material 42 in the form of a sheet was described, but no limitation is imposed thereby, and the electrode paste 41 may be applied to the ion-exchange membrane 15 in the form of a sheet.

The method for manufacturing an electrode layer for a fuel cell according to the present invention is suitable for manufacturing an electrode layer for a fuel cell in which the coated electrode material is dried to form an electrode layer.

Obviously, various minor changes and modifications of the present invention are possible in light of the above teaching. It is therefore to be understood that within the scope of the appended claims the invention may be practiced otherwise than as specifically described.

What is claimed is:

1. A method for manufacturing an electrode layer for a fuel cell, comprising the steps of:
providing a paste-form electrode material having a solvent that includes an ion-exchange resin;
applying the electrode material to a sheet-form base;
evaporating the solvent on a front surface of a layer of the electrode material so that a concentration of the ion-exchange resin contained in the electrode material layer applied to the base increases from the front surface toward a reverse surface, opposed to the base, of the electrode material layer; and
solidifying the electrode material layer by drying.

2. The method of claim 1, wherein the step for evaporating the solvent on the front surface comprises blowing air onto the front surface to facilitate evaporation of the solvent from the front surface.

3. The method of claim 1, wherein the step for evaporating the solvent on the front surface comprises setting an evaporation rate of the solvent contained in the electrode material layer to fall in a range of 23 to 66 wt %.

4. The method of claim 1, wherein the step for evaporating the solvent on the front surface comprises heating the electrode material layer to a temperature that allows the solvent contained in the electrode material layer to evaporate from the front surface and that prevents occurrence of convection of the solvent within the electrode material layer.
